(19) United States
(12) Patent Application Publication
(10) Pub. No.: US 2006/0219495 A1
(43) Pub. Date: Oct. 5, 2006

(54) Inertia brake

(76) Inventor: Kevin F. Schlosser, Auburn, IN (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/096,803

(22) Filed: Apr. 1, 2005

(51) Int. Cl. F16D 63/00

(52) U.S. Cl. 188/84

(57) ABSTRACT

A brake assembly for slowing rotation of a shaft is provided that includes a first reaction member, a second reaction member attached to and a moveably separated from the first reaction member by a resilient strap, and a rotor rotatably driven by and slideably disposed on the shaft. The rotor is retained between the first and second reaction members by the resilient strap. The strap separates the first and second reaction members to allow the rotor to rotate freely and is resiliently compressible to allow the first and second reaction members to selectively and frictionally engage the rotor. A vehicle powertrain system that includes a brake assembly according to the present invention is also provided.

### BACKGROUND OF THE INVENTION

1. Field of the Invention

The present invention relates to the field of inertia brakes and to an inertia brake assembly suitable for use with friction clutches in heavy duty vehicles.

2. Description of the Related Art

An inertia brake is a device used to rapidly slow the rotational speed of a transmission input shaft to facilitate the shifting of gears in the transmission. Without an inertia brake, the time required to shift a transmission would be significantly increased, thereby complicating operation of the transmission in several driving modes.

An inertia brake may include a disc-shaped rotor that is splined to a transmission input shaft and is activated by a master clutch release mechanism when the master clutch is disengaged. In one design, the rotor is positioned between two coil spring-separated plates that include a friction material for engaging the rotor. The release mechanism moves between engaged (near the clutch) and disengaged (nearer the transmission) positions, causing the master clutch to selectively connect and disconnect the transmission input shaft from the engine. Near the end of its disengagement stroke, the release mechanism compresses the inertia brake and forces the plates to contact the rotor. When so moved, rotation of the inertia brake rotor, and consequently the transmission input shaft, is slowed or stopped by virtue of the friction material on the plates contacting and imparting drag on the rotor.

Inertia brakes, while adequate for slowing rotation of a transmission input shaft, may include multiple independent parts that increase the complexity of their installation into a vehicle. Furthermore, the coil springs that separate the plates utilize guide studs that may bind and/or wear over time. Moreover, the use of guide studs may require that the metal plates be heat-treated to improve their durability.

### SUMMARY OF THE INVENTION

A brake assembly for slowing rotation of a shaft is provided. In an embodiment, the brake assembly includes a first reaction member, a second reaction member attached to and moveably separated from the first reaction member by a resilient strap, and a rotor rotatably driven by and slideably disposed on the shaft. The rotor is retained between the first and second reaction members by the resilient strap. The strap separates the first and second reaction members to allow the rotor to rotate freely and is resiliently compressible to allow the first and second reaction members to selectively and frictionally engage the rotor to slow its rotation. An inertia brake assembly for a transmission input shaft and a vehicle powertrain system that includes a brake assembly according to the present invention are also provided.

### BRIEF DESCRIPTION OF THE DRAWINGS

The features and inventive aspects of the present invention will become more apparent upon reading the following detailed description, claims, and drawings, of which the following is a brief description:

FIG. 1 is a schematic illustration of a vehicle powertrain system that includes an inertia brake;

FIG. 2 is an exploded perspective view of an inertia brake according to an embodiment of the present invention;

FIG. 3 is a perspective view of the inertia brake of FIG. 2 shown assembled;

FIG. 4 is a perspective view of the inertia brake of FIGS. 2 and 3 installed in an exemplary clutch housing;

FIG. 5 is a cross-sectional view of the inertia brake and clutch housing of FIG. 4, showing the inertia brake in an expanded state; and

FIG. 6 is a cross-sectional view of the inertia brake and clutch housing of FIG. 4, showing the inertia brake in a compressed state.

### DETAILED DESCRIPTION

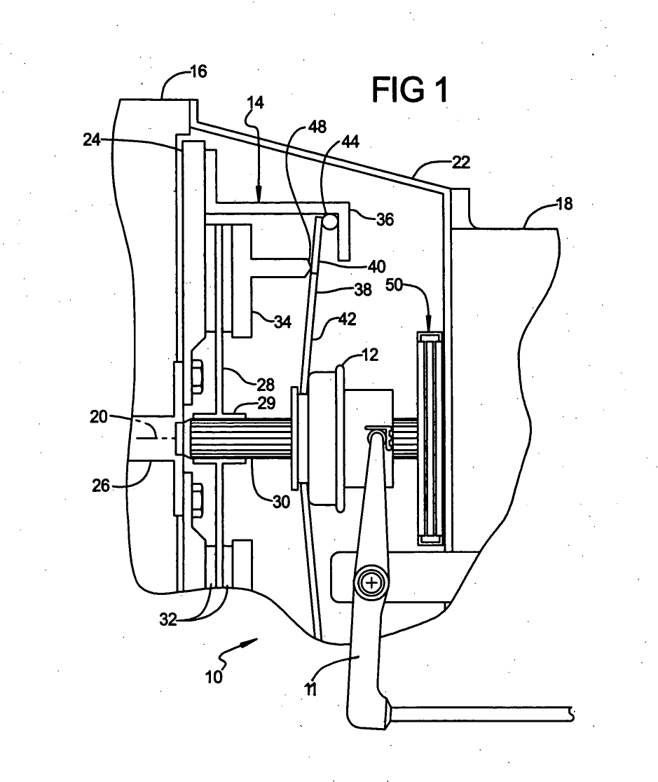

A schematic illustration of an exemplary vehicle powertrain system is shown in FIG. 1. In the illustrated vehicle powertrain system, a clutch assembly is provided that includes a clutch release mechanism 10 selectively actuated by a vehicle operator using a foot actuated clutch pedal (not shown). Movement of the clutch pedal is transferred through a linkage 11 to a clutch release member 12. Alternatively, actuation could be provided by an automated mechanism, such as an electric servo or fluid-powered actuator (neither shown).

In the exemplary clutch assembly, a single-disc (shown) or multi-disc friction clutch 14 drivingly connects an engine 16 with a transmission assembly 18 and rotates about an axis 20. A clutch housing 22, sometimes referred to as a bell housing, connects an engine block of engine 16 with a housing of transmission assembly 18. A flywheel 24 is rotatably fixed to a crankshaft 26 of engine 16. A driven disc 28, centered with respect to axis 20, has a splined hub portion 29 that slideably engages a splined input shaft 30 of transmission 18. Driven disc 28 is at least partially sandwiched between flywheel 24 and a pressure plate 34 and includes friction elements 32 that frictionally contact flywheel 24 and pressure plate 34 when clutch 14 is engaged.

In the illustrated clutch assembly, a cover 36 is disposed over pressure plate 34 and is fixed to flywheel 24. A plurality of straps (not shown) circumferentially extend between pressure plate 34 and cover 36. The straps rotatably fix pressure plate 34 to cover 36 while allowing axial displacement of pressure plate 34 relative to cover 36. The straps are adapted to serve as springs, which can be used to bias pressure plate 34 away from flywheel 24.

A diaphragm spring 38 is axially disposed between cover 36 and pressure plate 34. An annular portion 40 of diaphragm spring 38 biases pressure plate 34 toward flywheel 24, clamping driven disc 28 between flywheel 24 and pressure plate 34 to rotatably connect or lock input shaft 30 with flywheel 24 when clutch 10 is in an engaged position. Diaphragm spring 38 has a plurality of radially inwardly extending fingers 42, the inner tips of which are engaged by the axially displaceable release member 12. A pivot ring 44, or other pivot feature such as a bead formed in the cover, is axially disposed between an outer diameter of annular portion 40 and cover 36 to facilitate pivoting or flexing of annular portion 40 relative to cover 36.

Clutch 14 is selectively released or disengaged by axially displacing release member 12 along axis 20 in a direction away from flywheel 24 against the force of diaphragm spring 38. Such displacement is achieved by a vehicle operator depressing the pedal, for example, with the motion of the pedal being transferred via linkage 11 to displace release member 12. As the radially inner tips of fingers 42 are axially displaced away from flywheel 24, fingers 42 bow, causing annular portion 40 to deflect, thereby relieving the clamping load against pressure plate 34, and permitting rotation of input shaft 30 relative to flywheel 24. Annular portion 40 engages a fulcrum 48 of pressure plate 34 proximate to an inner diameter of annular portion 40.

In the illustrated embodiment, clutch housing 22 provides a grounded surface against which an inertia brake 50 may be compressed by the axial movement of release member 12. Release member 12 is moved axially to press against inertia brake 50 when clutch 14 is disengaged and it is desired to slow rotation of transmission input shaft 30 to facilitate a gear ratio change in transmission 18. Alternatively, a portion of transmission 18, such as the transmission housing, may provide the grounded surface against which inertia brake 50 is compressed when clutch 14 is disengaged.

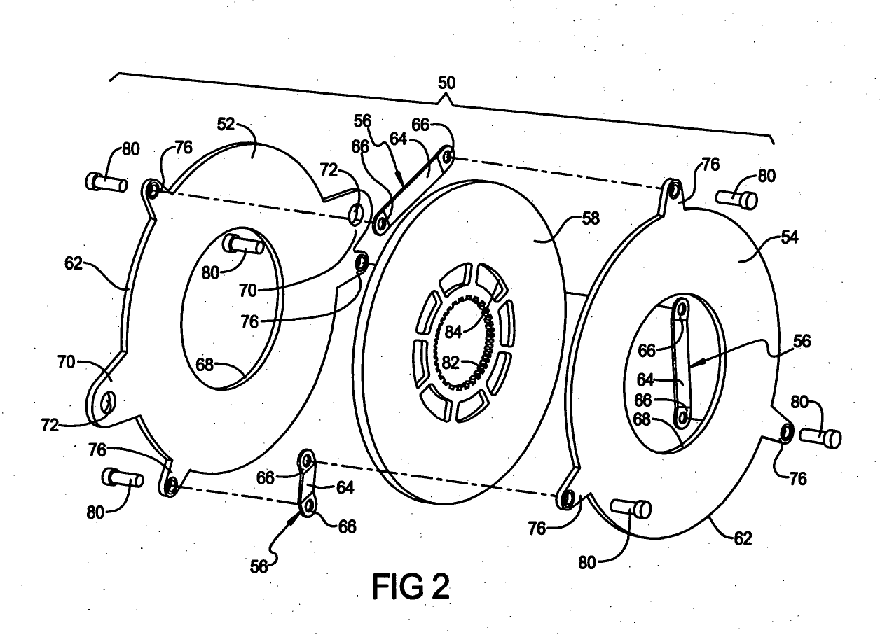

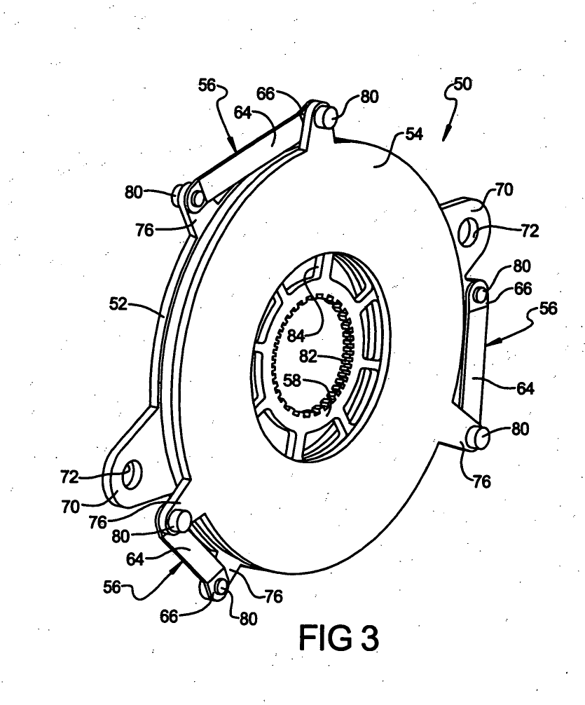

Referring to FIGS. 2 and 3, an inertia brake assembly 50 according to an embodiment of the present invention is shown. Inertia brake assembly 50 includes a first reaction member 52, a second reaction member 54 attached to and moveably separated from first reaction member 52 by at least one resilient strap 56. Inertia brake assembly 50 also includes a rotor 58 rotatably driven by and slideably disposed on input shaft 30. When inertia brake 50 is assembled, rotor 58 is retained between first and second reaction members 52, 54 by resilient strap 56. Resilient strap 56 separates first and second reaction members 52, 54 to allow rotor 58 to rotate freely and is resiliently compressible to allow first and second reaction members 52, 54 to selectively and frictionally engage rotor 58.

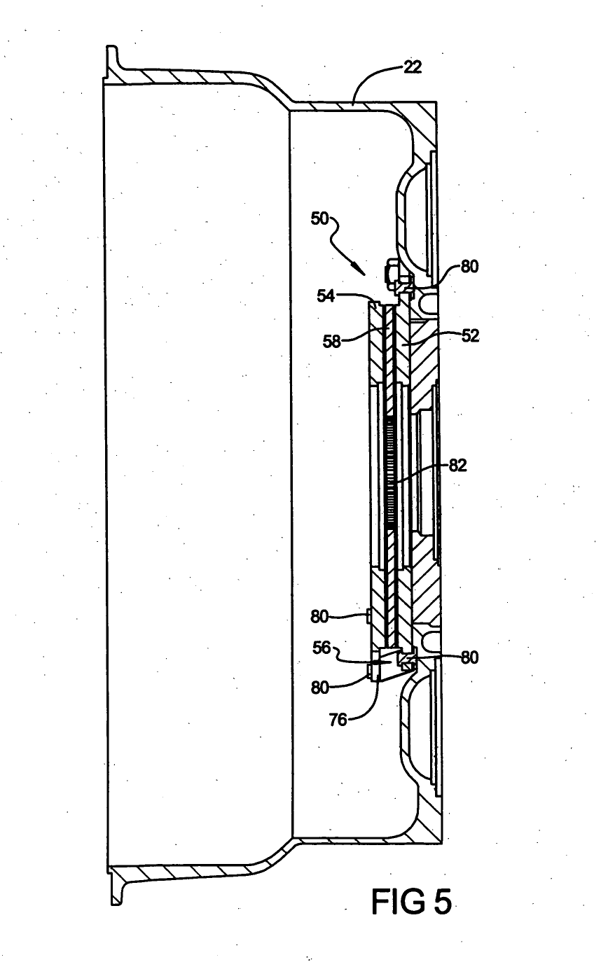

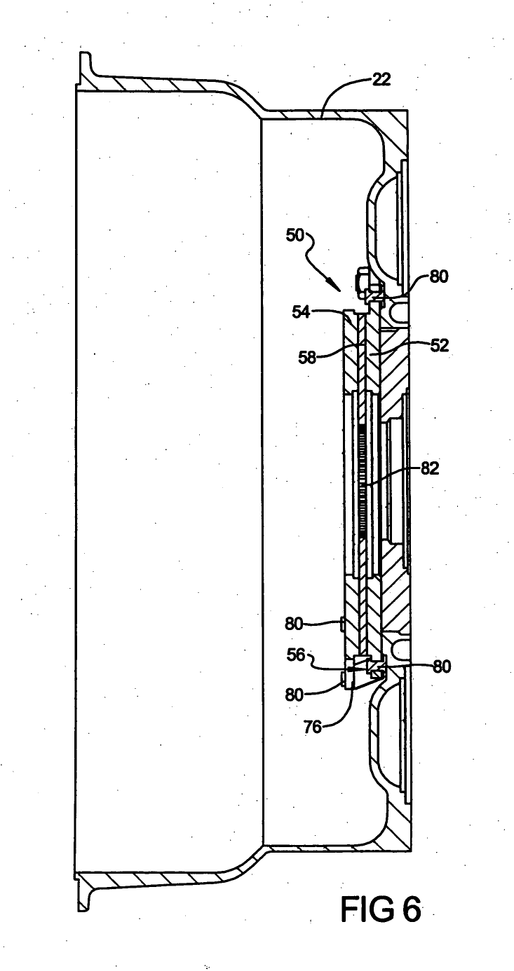

In an embodiment, second reaction member 54 is attached to and moveably separated from first reaction member 52 by a plurality of resilient straps 56. Straps 56 may be positioned about a circumferential edge 62 of first and second reaction members 52, 54 to retain rotor 58 therebetween. Straps 56 may non-rotatably fix first reaction member 52 to second reaction member 54 while allowing axial displacement of second reaction member 54 relative to first reaction member 52. In the embodiment shown in FIGS. 2 and 3, straps 56 include a main strap portion 64 that retains rotor 58 between first and second reaction members 52, 54 and a pair of reaction member attachment tabs 66 that are axially separated (see, e.g., FIGS. 5 and 6) to accommodate a spin gap (i.e., gap that permits rotation of rotor 58) between first and second reaction members 52, 54 and the thickness of rotor 58. Straps 56 may be made from a resilient material, such as spring steel, which allows reaction member attachment tabs 66 to pivot relative main strap portion 64 during compression of brake assembly 50.

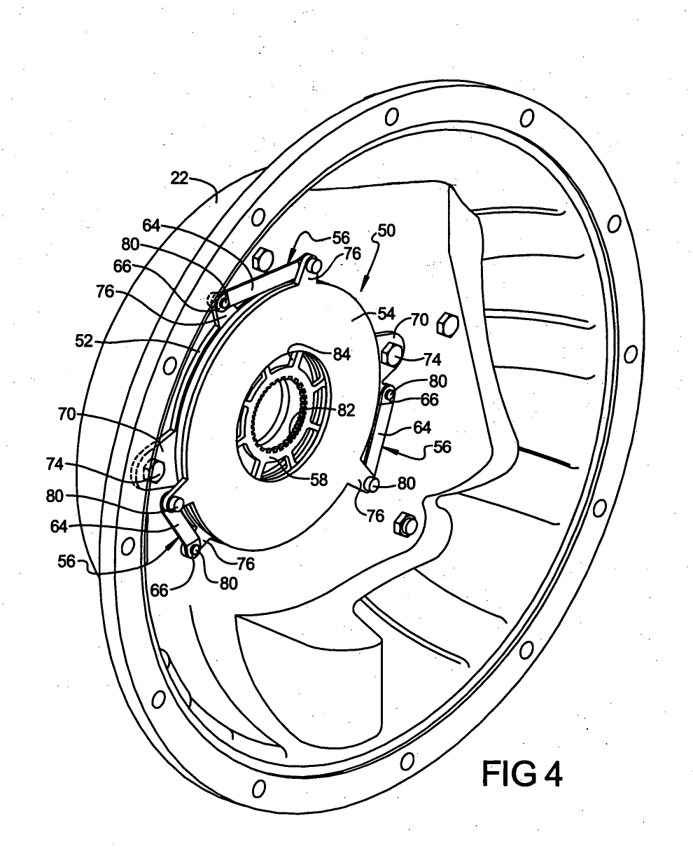

In an embodiment, first and second reaction members 52, 54 are generally annular plates that include a hole 68 for passage of input shaft 30. To secure brake assembly 50 to clutch housing 22, first reaction member 52 may include at least one mounting bracket 70. Mounting bracket 70 includes a hole or aperture 72 that aligns with a corresponding hole or aperture in clutch housing 22 (or a transmission housing as noted above) to cooperatively receive a fastener 74 (see, e.g., FIG. 4), such as a bolt and the like, for securing brake assembly 50 to clutch housing 22 (or transmission housing). First and second reaction members 52, 54 may also include strap attachment brackets 76 having a hole or aperture that aligns with a corresponding hole or aperture in reaction member attachment tabs 66 to cooperatively receive a fastener 80, such as a rivet and the like, for securing strap 56 to first and second reaction members 52, 54. Strap attachment brackets 76 may be positioned on first and second reaction members 52, 54 so that each strap 56 does not overlap mounting bracket 70 or otherwise impede passage of fastener 74 through the mounting bracket hole or aperture 72 when brake assembly 50 is secured to clutch housing 22.

To facilitate a relatively rapid reduction in speed of rotor 58, a rotor-facing side of first and second reaction members 52, 54 may include a friction material (not shown). The friction material may be adapted to cover substantially all of or only a portion of each reaction member 52, 54. Any suitable friction material may be provided on reaction members 52 and 54, including those materials used in conventional clutch brakes. Since reaction members 52, 54 may be made from a low carbon steel, such as AISI 1008 and AISI 1010 steel, the friction material may be readily bonded to reaction members 52, 54 using known bonding processes. Furthermore, low carbon steel does not require heat-treatment and the manufacturing expense associated therewith.

In an embodiment, rotor 58 is a generally smooth metal disc, which includes an internal spline 82 that secures rotor 58 for rotation with input shaft 30. When so configured, rotor 58 is axially slideable in relation to both input shaft 30 and first and second reaction members 52, 54. Alternatively, rotor 58 may be configured as a torque-limiting rotor.

At least one hole 84 may be provided in rotor 58 to reduce its weight and/or facilitate cooling when frictionally engaged by first and second reaction members 52, 54. If desired, tabs or other features (not shown) may be formed in first and second reaction members 52, 54 to constrain rotor 58 on input shaft 30 and/or more precisely position rotor 58 within brake assembly 50 for installation in clutch housing 22.

Operation of brake assembly 20 will now be described with reference to FIGS. 1, 5 and 6. When clutch 14 is engaged, release member 12 is disengaged from brake assembly 50 and first and second reaction members 52, 54 are spaced apart from rotor 58 due to the spring force applied by straps 56 (see, e.g., FIGS. 1 and 5). In this manner, rotor 58 is free to rotate with input shaft 30 as torque is transmitted from engine 16 through clutch 14 and into transmission 18.

When it is desired to rapidly slow rotation of input shaft 30 to facilitate a gear ratio change in transmission 18, clutch 14 is disengaged and release member 12 is moved axial into contact with second reaction member 54. Release member 12 compresses brake assembly 50 against clutch housing 22, causing each of first and second reaction plates 52, 54 to frictionally contact rotor 58 (see, e.g., FIG. 6). The frictional contact between first and second reactions members 52, 54 and rotor 58 slows or stops rotation of rotor 58 and consequently input shaft 30. When clutch 14 is re-engaged, release member 12 disengages from brake assembly 50, allowing the spring force of straps 56 to separate second reaction plate 54 from first reaction plate 52 and rotor 58 to rotate freely.

Although brake assembly 50 of the present invention is particularly suited for use as an inertia brake for slowing rotation of a transmission input shaft disposed between a clutch and a transmission of a motor vehicle, brake assembly 50 may be used in other applications requiring the rotational slowing of a shaft.

The present invention has been shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A brake assembly for slowing rotation of a shaft, the brake assembly comprising:
a first reaction member;
a second reaction member attached to and moveably separated from the first reaction member by a resilient strap; and
a rotor rotatably driven by and slideably disposed on the shaft, the rotor retained between the first and second reaction members by the resilient strap, whereby the resilient strap separates the first and second reaction members to allow the rotor to rotate freely and is resiliently compressible to allow the first and second reaction members to selectively and frictionally engage the rotor.

2. The brake assembly of claim 1, wherein the second reaction member is attached to and moveably separated from the first reaction member by a plurality of resilient straps.

3. The brake assembly of claim 2, wherein the resilient straps are positioned about a circumference of the first and second reaction members to retain the rotor therebetween.

4. The brake assembly of claim 1, wherein the resilient strap is attached to the first and second reaction members proximate a circumferential edge of the first and second reaction members.

5. The brake assembly of claim 1, wherein the resilient strap non-rotatably fixes the first reaction member to the second reaction member while allowing axial displacement of the second reaction member relative to the first reaction member.

6. The brake assembly of claim 1, wherein the resilient strap includes a main strap portion that retains the rotor between the first and second reaction members and a pair of reaction member attachment tabs that are axially separated to accommodate the thickness of the rotor.

7. The brake assembly of claim 1, wherein a rotor-facing side of the first and second reaction members includes a friction material.

8. An inertia brake assembly for slowing rotation of a shaft that extends between a vehicle transmission and a clutch having a release member, the inertia brake assembly comprising:
a first reaction member;
a second reaction member attached to and moveably separated from the first reaction member by a resilient strap, the second reaction member positioned to be selectively engaged by the release member to move the second reaction member toward the first reaction member; and
a rotor rotatably driven by and slideably disposed on the shaft, the rotor retained between the first and second reaction members by the resilient strap, whereby the resilient strap separates the first and second reaction members to allow the rotor to rotate freely and is resiliently compressible to allow the first and second reaction members to selectively and frictionally engage the rotor.

9. The inertia brake assembly of claim 8, wherein the second reaction member is attached to and moveably separated from the first reaction member by a plurality of resilient straps.

10. The inertia brake assembly of claim 9, wherein the resilient straps are positioned about a circumference of the first and second reaction members to retain the rotor therebetween.

11. The inertia brake assembly of claim 8, wherein the resilient strap is attached to the first and second reaction members proximate a circumferential edge of the first and second reaction members.

12. The inertia brake assembly of claim 8, wherein the resilient strap non-rotatably fixes the first reaction member to the second reaction member while allowing axial displacement of the second reaction member relative to the first reaction member.

13. The inertia brake assembly of claim 8, wherein the resilient strap includes a main strap portion that retains the rotor between the first and second reaction members and a pair of reaction member attachment tabs that are axially separated to accommodate the thickness of the rotor.

14. The inertia brake assembly of claim 8, wherein a rotor-facing side of the first and second reaction members includes a friction material.

15. A vehicle powertrain system comprising:
a clutch having a clutch housing;
a transmission having a transmission housing;
a shaft for transmitting rotational power between the clutch and the transmission;
an inertia brake assembly including a first reaction member, a second reaction member attached to and moveably separated from the first reaction member by a resilient strap, and a rotor rotatably driven by and slideably disposed on the shaft, the rotor retained between the first and second reaction members by the resilient strap, whereby the resilient strap separates the first and second reaction members to allow the rotor to rotate freely and is resiliently compressible to allow the first and second reaction members to selectively and frictionally engage the rotor;
a release member slideably disposed over or about the shaft, the release member adapted to compress the brake assembly against at least one of the clutch housing and the transmission housing, causing the first and second reaction members to frictionally engage the rotor.

16. The vehicle powertrain system of claim 15, wherein the second reaction member is attached to and moveably separated from the first reaction member by a plurality of resilient straps.

17. The vehicle powertrain system of claim 16, wherein the resilient straps are positioned about a circumference of the first and second reaction member to retain the rotor therebetween.

18. The vehicle powertrain system of claim 15, wherein a rotor-facing side of the first and second reaction members includes a friction material.

19. The vehicle powertrain system of claim 15, wherein the first reaction member includes a primary mounting bracket having a hole or aperture that aligns with a corresponding hole or aperture in at least one of the transmission housing and the clutch housing to cooperatively receive a fastener for securing the inertia brake assembly to the transmission housing or the clutch housing.

20. The vehicle powertrain system of claim 19, wherein the first and second reaction members include attachment brackets having a hole or aperture that aligns with a corresponding hole or aperture in the resilient strap to cooperatively receive a fastener for securing the resilient strap to the first and second reaction members.

21. The vehicle powertrain system of claim 20, wherein the attachment brackets are positioned on the first and second reaction members so that the resilient strap does not overlap the mounting bracket or otherwise impede passage of the fastener through the mounting bracket hole or aperture when the inertia brake assembly is secured to at least one of the transmission housing and the clutch housing.
